(19) United States
(12) Patent Application Publication
(10) Pub. No.: US 2015/0063253 A1
(43) Pub. Date: Mar. 5, 2015

(54) METHODS FOR NEIGHBOR CSI-RS DETECTION

(71) Applicant: QUALCOMM INCORPORATED, San Diego, CA (US)

(72) Inventors: Alan Barbieri, La Jolla, CA (US); Milos Jorgovanovic, Berkeley, CA (US); Tao Luo, San Diego, CA (US)

(21) Appl. No.: 14/460,827

(22) Filed: Aug. 15, 2014

Related U.S. Application Data
(60) Provisional application No. 61/874,187, filed on Sep. 5, 2013.

(51) Int. Cl. H04L 5/00

(52) U.S. Cl. CPC H04L 5/0048
USPC 370/329

(57) ABSTRACT

Methods, systems, and devices are described for identifying channel state information reference signals (CSI-RS) from a non-serving cell in a wireless communications network. A subset of virtual cell identity (VCID) candidates may be identified, and one or more CSI-RS locations for one or more CSI-RS in a received signal from a non-serving cell may be determined The CSI-RS locations may be determined based on periodicity properties of CSI-RS transmissions of the subset of VCID candidates. The one or more determined locations in the received signal may be used to identify the one or more CSI-RS in the received signal through searching the locations for all available VCIDs in a set of VCIDs.

### CROSS REFERENCES

The present Application for Patent claims priority to U.S. Provisional Patent Application No. 61/874,187 by Barbieri et al., entitled “Methods for Neighbor CSI-RS Detection,” filed Sep. 5, 2013, assigned to the assignee hereof, and expressly incorporated by reference herein.

### BACKGROUND

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include a number of base stations or Node-Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

Multiple base stations may have overlapping coverage areas, and a UE may receive signals from a serving cell, as well as one or more potentially interfering signals from one or more non-serving cells. Various techniques exist for mitigation of interference from non-serving cells. For example, if a UE has a channel estimation of a signal from a non-serving cell, this information may be used to derive equalizer coefficients for the UE receiver and reduce the effects of the interfering signal on a signal from the UE's serving cell. Interference mitigation techniques may also include, for example, interference suppression (IS), minimum mean square error (MMSE) interference rejection, multi-user detection (MUD), joint maximum likelihood (ML) detection, symbol-level interference cancellation (SLIC), and/or codeword-level interference cancellation (CWIC). Such interference mitigation techniques may be enhanced if a UE has information related to the potentially interfering signals.

### SUMMARY

Methods and apparatuses are described for identifying one or more channel state information reference signal (CSI-RS) from a non-serving cell in a wireless communications network. In some examples, a subset of virtual cell identity (VCID) candidates may be identified, and one or more CSI-RS locations for one or more CSI-RS in a received signal from a non-serving cell may be determined The CSI-RS locations may be determined, for example, based on periodicity properties of CSI-RS transmissions of the subset of VCID candidates. The one or more determined locations in the received signal may be used to identify the one or more CSI-RS in the received signal through searching the locations for all available VCIDs in a set of VCIDs.

A method for identifying one or more channel state information reference signal (CSI-RS) from a non-serving cell in a wireless communications network is described. The method may include identifying a subset of virtual cell identity (VCID) candidates, determining one or more CSI-RS locations for one or more CSI-RS in a received signal from a non-serving cell based on the subset of VCID candidates, and identifying one or more CSI-RS in the received signal based on the one or more CSI-RS locations. Identifying the one or more CSI-RS may include, for example, determining one or more of a subframe configuration, a resource configuration, a VCID, or an antenna port configuration for a CSI-RS contained in the received signal.

In some examples, identifying the one or more CSI-RS may include, for each CSI-RS location from the one or more CSI-RS locations, searching for a VCID, in a set of available VCIDs, corresponding to a CSI-RS sequence generated according to the VCID at the CSI-RS location, and determining the one or more CSI-RS responsive to the searching. The searching may include, for example, estimating one or more of a delay spread or power delay profile (PDP) of the received signal, averaging frequency domain samples of the received signal according to the estimated delay or PDP, and testing the averaged frequency domain samples with the VCID to determine whether the averaged frequency domain samples contain a CSI-RS based on the VCID. The estimating may be based on one or more antenna ports associated with a common reference signal (CRS), for example. The CRS antenna port(s) to be used for the estimation may be signaled by a network entity of the wireless communications network, or selected autonomously based on at least one of a physical cell identity (PCI), the CSI-RS location, or the VCID.

In some examples, the identifying the subset of VCID candidates may include selecting the subset of VCID candidates from a number of subsets of VCID candidates. The method may also include, in some examples, identifying one or more particular CSI-RS locations, and the selecting may include selecting the subset of VCID candidates from the number of subsets of VCID candidates responsive to the identifying. The identifying one or more particular CSI-RS locations may be based on, for example, information received from a network entity of the wireless communications network that restricts allowed locations for a CSI-RS. The VCID subsets may be provided in radio resource control (RRC) signaling, in some examples.

In some examples, the one or more CSI-RS locations may include time-domain locations, which may include, for example, a subframe configuration and/or a resource configuration for a CSI-RS contained in the received signal. In some examples, determining the one or more CSI-RS locations may include identifying a subset of subframes, measuring a time-domain correlation of received frequency domain samples across the subset of subframes for each VCID from the subset of VCID candidates, and determining the one or more CSI-RS locations based on the measured time-domain correlation.

In some examples, selecting the subset of VCID candidates may be based on, one or more of a physical cell identifier (PCI) of one or more non-serving cells, a random selection from a set of available VCID candidates, an indication of available VCID candidates provided by a network entity of the wireless communications network, cross-correlation measurements between VCID pairs from a set of available VCID candidates, information provided by a network entity of the wireless communications network, or a combination thereof. In some examples, the one or more CSI-RS locations may be determined irrespective of whether a CSI-RS contained in the received signal has a VCID in the identified subset of VCID candidates.

An apparatus for identifying one or more CSI-RS from a non-serving cell in a wireless communications network is described. The apparatus may include means for identifying a subset of VCID candidates, means for determining one or more CSI-RS locations for one or more CSI-RS in a received signal from a non-serving cell based on the subset of VCID candidates, and means for identifying one or more CSI-RS in the received signal based on the one or more CSI-RS locations. The means for identifying may determine, for example, one or more of a subframe configuration, a resource configuration, a VCID, or an antenna port configuration for a CSI-RS contained in the received signal. In some examples, the means for identifying the one or more CSI-RS, for each CSI-RS location from the one or more CSI-RS locations, may search for a VCID, in a set of available VCIDs, corresponding to a CSI-RS sequence generated according to the VCID at the CSI-RS location, and determine the one or more CSI-RS responsive to the search.

In some examples, the means for identifying the subset of VCID candidates may select the subset of VCID candidates from a number of subsets of VCID candidates. The CSI-RS locations may include, for example, a subframe configuration and/or a resource configuration for a CSI-RS contained in the received signal. The means for selecting the subset of VCID candidates may select the subset of VCID candidates based on, for example, one or more of a physical cell identifier (PCI) of one or more non-serving cells, a random selection from a set of available VCID candidates, a set of available VCID candidates provided by a network entity of the wireless communications network, cross-correlation measurements between VCID pairs from a set of available VCID candidates, information provided by a network entity of the wireless communications network, or a combination thereof. In some examples, the one or more CSI-RS locations may be determined irrespective of whether a CSI-RS contained in the received signal has a VCID in the identified subset of VCID candidates.

A device for identifying one or more CSI-RS from a non-serving cell in a wireless communications network including a processor and a memory in electronic communication with the processor is described. The memory may embody instructions being executable by the processor to identify a subset of VCID candidates, determine one or more CSI-RS locations for one or more CSI-RS in a received signal from a non-serving cell based on the subset of VCID candidates, and identify one or more CSI-RS in the received signal based on the one or more CSI-RS locations. The instructions may be executable by the processor to determine, for example, one or more of a subframe configuration, a resource configuration, a VCID, or an antenna port configuration for a CSI-RS contained in the received signal. The memory may also embody instructions being executable by the processor to, for each CSI-RS location from the one or more CSI-RS locations, search for a VCID, in a set of available VCIDs, corresponding to a CSI-RS sequence generated according to the VCID at the CSI-RS location, and determine the one or more CSI-RS responsive to the searching.

In some examples, the memory may further embody instructions being executable by the processor to estimate one or more of a delay spread or power delay profile (PDP) of the received signal, average frequency domain samples of the received signal according to the estimated delay or PDP, and test the averaged frequency domain samples with the VCID to determine whether the averaged frequency domain samples contain a CSI-RS based on the VCID. The estimate may be based on one or more antenna ports associated with a CRS.

In some examples, the memory may further embody instructions being executable by the processor to select the subset of VCID candidates from a number of subsets of VCID candidates, identify one or more particular CSI-RS locations, and select the subset of VCID candidates from the number of subsets of VCID candidates responsive to the identification. The CSI-RS locations may include, for example, a subframe configuration and/or a resource configuration for a CSI-RS contained in the received signal. In some examples, the memory may further embody instructions being executable by the processor to identify a subset of subframes, measure a time-domain correlation of received frequency domain samples across the subset of subframes for each VCID from the subset of VCID candidates, and determine the one or more CSI-RS locations based on the measured time-domain correlation.

A non-transitory computer-readable medium for identifying one or more CSI-RS from a non-serving cell in a wireless communications network is described. The computer readable medium may include code for identifying a subset of VCID candidates, determining one or more CSI-RS locations for one or more CSI-RS in a received signal from a non-serving cell based on the subset of VCID candidates, and identifying one or more CSI-RS in the received signal based on the one or more CSI-RS locations. The computer-readable medium may include code for determining one or more of a subframe configuration, a resource configuration, a VCID, or an antenna port configuration for a CSI-RS contained in the received signal, for example. The computer-readable medium may also include code for, for each CSI-RS location from the one or more CSI-RS locations, searching for a VCID, in a set of available VCIDs, corresponding to a CSI-RS sequence generated according to the VCID at the CSI-RS location, and determining the one or more CSI-RS responsive to the searching.

In some examples, the computer-readable medium may also include code for estimating one or more of a delay spread or PDP of the received signal, averaging frequency domain samples of the received signal according to the estimated delay or PDP, and testing the averaged frequency domain samples with the VCID to determine whether the averaged frequency domain samples contain a CSI-RS based on the VCID. The computer-readable medium may also include code for selecting the subset of VCID candidates from a number of subsets of VCID candidates, identifying one or more particular CSI-RS locations, and selecting the subset of VCID candidates from the number of subsets of VCID candidates responsive to the identification. The CSI-RS locations may include, for example, a subframe configuration and/or a resource configuration for a CSI-RS contained in the received signal. In some examples, the computer-readable medium may include code for identifying a subset of subframes, measuring a time-domain correlation of received frequency domain samples across the subset of subframes for each VCID from the subset of VCID candidates, and determining the one or more CSI-RS locations based on the measured time-domain correlation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of a wireless communications system according to various aspects of the disclosure;

FIG. 2 shows a diagram that illustrates an example of interfering cells in a wireless communications system according to various aspects of the disclosure;

FIG. 3 shows an example of CSI-RS locations within an LTE signal transmission according to various aspects of the disclosure;

FIG. 4 shows a flow diagram of an example method for identifying a CSI-RS from a non-serving cell according to various aspects of the disclosure;

FIG. 5 shows a flow diagram of an example method for determining CSI-RS locations based on a subset of VCID candidates according to various aspects of the disclosure;

FIG. 6 shows a flow diagram of an example method for identifying a CSI-RS based on CSI-RS location information according to various aspects of the disclosure;

FIGS. 7A and 7B show block diagrams of examples of devices, such as eNBs or UEs, for use in wireless communications according to various aspects of the disclosure;

FIG. 8 shows a block diagram of a CSI-RS identification module according to various aspects of the disclosure;

FIG. 9 shows a block diagram that illustrates an example of an eNB architecture according to various aspects of the disclosure;

FIG. 10 shows a block diagram that illustrates an example of a UE architecture according to various aspects of the disclosure; and

FIG. 11 shows a block diagram of a MIMO communication system including a base station and a mobile device according to various aspects of the disclosure.

### DETAILED DESCRIPTION

Described embodiments are directed to systems and methods for wireless communications in which one, or more, channel state information reference signal (CSI-RS) from a non-serving cell in a wireless communications network may be identified. In embodiments, a subset of virtual cell identity (VCID) candidates may be identified. The subset of VCID candidates may be identified, for example, through random selection, use of physical cell identifiers (PCIs) for neighboring cells, and/or selection of a subset from a number of available subsets. Information related to the identification of the VCID subset may be signaled through radio resource control (RRC) signaling. The subset of VCIDs may be used to determine CSI-RS locations for the CSI-RS(s) in a received signal from a non-serving cell. The CSI-RS locations may be determined, for example, based on periodicity properties of CSI-RS transmissions of the subset of VCID candidates. The determined CSI-RS locations in the received signal may be used to identify the one or more CSI-RS in the received signal through searching each location for a VCID corresponding to a CSI-RS sequence generated according to the VCID at the CSI-RS location, for example.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

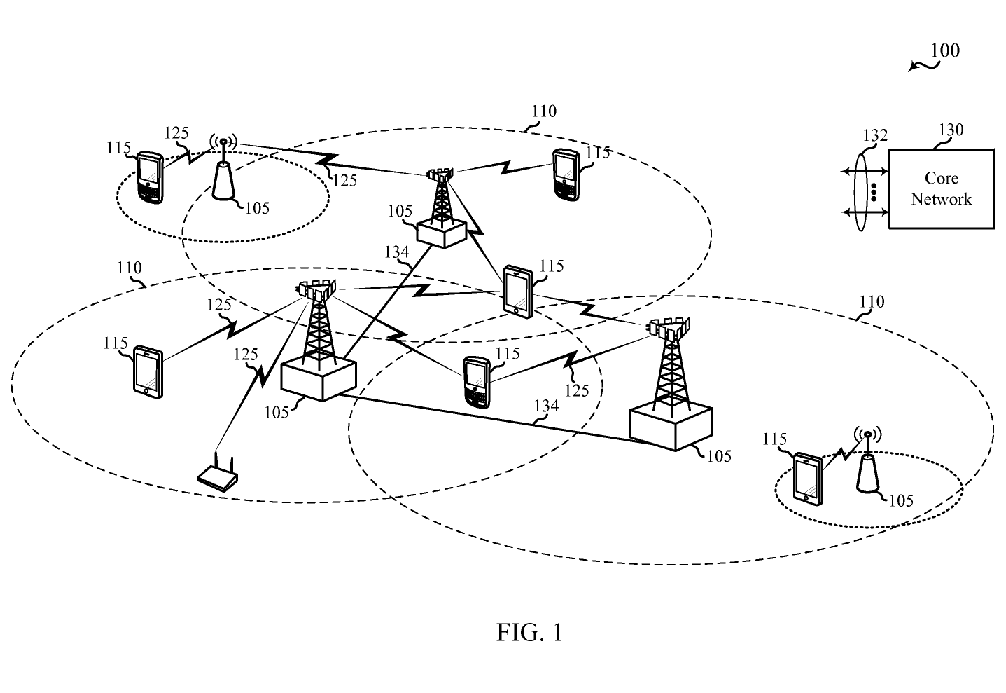

Referring first to FIG. 1, a diagram illustrates an example of a wireless communications system 100. The wireless communications system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

In embodiments, the wireless communications system 100 is an LTE/LTE-A network. In LTE/LTE-A networks, the terms evolved Node B (eNB) and user equipment (UE) may be generally used to describe the base stations 105 and devices 115, respectively. The wireless communications system 100 may be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. Femto cells and pico cells may be referred to generally as small cells. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul links 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 are dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a wearable device, a tablet computer, a laptop computer, a cordless phone, a wireless local loop (WLL) station, or the like. A UE may be able to communicate with macro eNBs, pico eNBs, femto eNBs, relays, and the like.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

The communication links 125 shown in the wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. In some embodiments of the wireless communications system 100, base stations 105 and/or UEs 115 may include multiple antennas for employing antenna diversity schemes to improve communication quality and reliability between base stations 105 and UEs 115.

The UEs 115 may be configured to collaboratively communicate with multiple base stations 105 through, for example, Multiple Input Multiple Output (MIMO), Coordinated Multi-Point (CoMP), or other schemes. MIMO techniques use multiple antennas on the base stations 105 and/or multiple antennas on the UEs 115 to transmit multiple data streams. CoMP includes techniques for dynamic coordination of transmission and reception by a number of base stations 105 to improve overall transmission quality for UEs 115 as well as increasing network and spectrum utilization. Such MIMO and/or CoMP techniques may provide for enhanced user experiences by providing enhanced overall bandwidth for data transmission in the system 100.

As is well understood, data may be transmitted to a UE using a shared channel, such as a physical downlink shared channel (PDSCH), which may be associated with the physical cell ID (PCI) of the transmitting base station 105. For example, the scrambling sequence for the PDSCH may be initialized with a seed based on the PCI of the transmitting base station 105. For various CoMP scenarios, however, the PDSCH may be transmitted using a virtual cell ID (VCID). For example, the scrambling sequence for the shared channel and the control channel in a cell can be initialized with a seed based on a VCID. The VCID may or may not be the same as the PCI, and may be specified for CoMP and MIMO operation, such as dynamic cell selection, decoupled control and data, multi-user MIMO (MU-MIMO) in a cell.

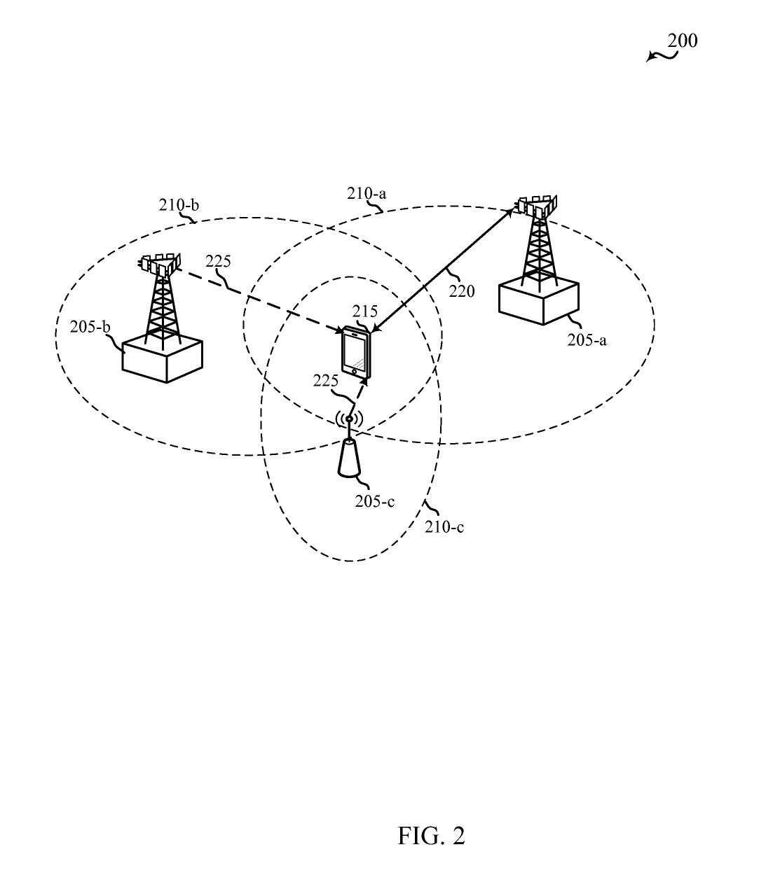

As indicated above, different base stations 105 may have overlapping coverage areas 110, and a UE 115 within a coverage area 110 may receive potentially interfering signals from one or more non-serving base stations 105. UEs 115 may employ one or more interference mitigation techniques to compensate for such interfering signals. In some interference mitigation techniques, knowledge of various characteristics of an interfering signal may significantly enhance interference mitigation. According to various embodiments described herein, various techniques may be used to detect a channel state information reference signal (CSI-RS) from a non-serving base station 105. The detection of a CSI-RS may allow a receiver, such as a UE 115, to enhance performance of interference cancelation techniques in order to mitigate the effect of interference that may be present. Additional details regarding the detection of CSI-RSs in a system, such as the wireless communications system 100, as well as other features and functions, are provided below with reference to FIGS. 2-11.

With reference now to FIG. 2, a diagram illustrating an example of a wireless communications system 200 in which interference may occur is described. The wireless communications system 200 may be an example of portions of the wireless communications system 100 described with reference to FIG. 1. The wireless communications system 200 includes a number of base stations or eNBs 205, which may be examples of base stations or eNBs 105 described with reference to FIG. 1. The eNBs 205 may communicate with a UE 215, which may be an example a UE 115 described with reference to FIG. 1. In the example of FIG. 2, a serving eNB 205-a may communicate with the UE 215 using bidirectional link 220, and two non-serving eNBs 205-b and 205-c may transmit interfering signals 225 that may be received at UE 215. Each eNB 205 may have a corresponding coverage area 210.

Various techniques exist for mitigation of interfering signals 225 at the UE 215. For example, if the UE 215 has a channel estimation of one or more of interfering signals 225, this information may be used to derive equalizer coefficients for the UE 215 receiver and reduce the effects of the interfering signal 225. Interference mitigation techniques may also include, for example, interference suppression (IS), minimum mean square error (MMSE) interference rejection, multi-user detection (MUD), joint maximum likelihood (ML) detection, symbol-level interference cancellation (SLIC), and/or codeword-level interference cancellation (CWIC). According to various embodiments, the UE 215 may identify one or more CSI-RS transmissions from interfering eNBs 205-b and 205-c. Detection of CSI-RS transmissions from eNBs 205-b and 205-c may allow the UE 215 to estimate the channel from the non-serving eNBs 205-b and 205-c, and cancel interfering CSI-RS transmissions. Detection of CSI-RS transmissions may also allow the UE 215 to determine VCIDs of the non-serving eNBs 205-b and 205-c. Additionally or alternatively, detection of CSI-RS transmissions may allow UE 215 to determine resource element (RE) locations of interfering signals 225 where rate matching is carried out, and/or may allow UE 215 to determine tone matching at non-serving eNBs 205-b and 205-c. Furthermore, in some embodiments, the UE 215 may also identify one or more CSI-RS transmissions from the serving cell 205-a in cases where the UE 215 may not be aware of all CSI-RS transmissions from the serving cell 205-a.

Detection of CSI-RS transmissions, according to various embodiments, may be performed by the UE 215 without network assistance provided by the eNB 205-a. In other embodiments, detection of CSI-RS transmissions may be performed by the UE 215 with some amount of network assistance, such as an indication of one or more restrictions on allowed CSI-RS transmissions. In any event, detection of CSI-RS transmissions with little or no network assistance requires that the UE 215 determine locations of CSI-RS transmissions, identities of the transmitting cell, and number of antenna ports used by the transmitting cell. The locations of CSI-RS transmissions may include a subframe configuration and/or a resource configuration for the CSI-RS transmission. Identities of the transmitting cell may include a PCI or VCID. The number of potential permutations for CSI-RS transmissions can therefore be quite large, as numerous options for each of these items may exist. In some deployments, for example, the possible number of CSI-RS configurations, without any network restrictions, is over 1.5 million. Even with one or more network restrictions, such as restrictions on allowed CSI-RS transmissions, the possible number of CSI-RS configurations may be very large. According to various embodiments, the UE 215 may first determine CSI-RS locations through analysis of a subset of VCID candidates, and may then detect one or more CSI-RS in received interfering signals 225 through an exhaustive search over all VCID candidates only for the determined CSI-RS locations. Such CSI-RS detection will be described in more detail below.

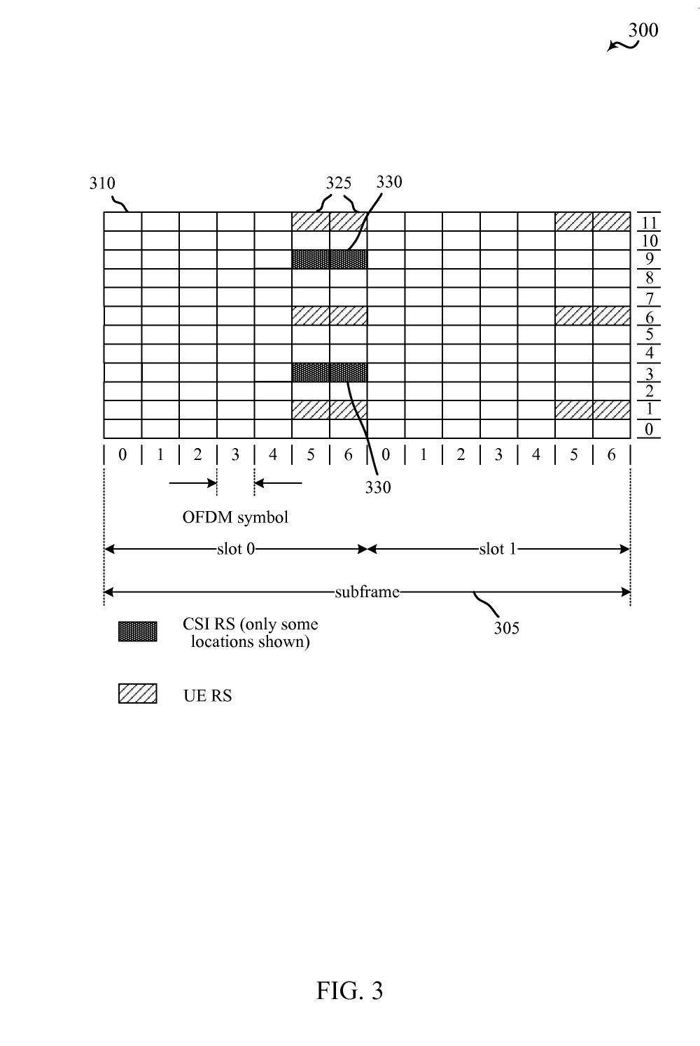

With reference now to FIG. 3, a diagram illustrates an example of a subframe structure 300 that may be used in a wireless communications system, including the wireless communications systems 100 and/or 200 described above with reference to FIGS. 1 and/or 2. In this example, the subframe structure 300 may be transmitted during a frame (10 ms) that may be divided into 10 equally sized subframes 305. Each subframe 305 may include two consecutive time slots, namely slot 0 and slot 1. An OFDMA component carrier may be illustrated as a resource grid representing two time slots. The resource grid may be divided into multiple resource elements 310.

In LTE/LTE-A, a resource block may contain 12 consecutive subcarriers (numbered 0-11 in FIG. 3) in the frequency domain and, for a normal cyclic prefix in each OFDM symbol, 7 consecutive OFDM symbols in the time domain, or 84 resource elements 310 per slot. Some of the resource elements, shaded and denoted 330, may include a CSI RS transmission. Note additional resource blocks other than illustrated in FIG. 3 may include such CSI-RS transmissions. Furthermore, other resource elements 310 may include one or more reference signals other than a CSI-RS such as, for example, one or more UE-specific RS (UE-RS), shaded and denoted 325. Various other reference signals may be transmitted by an eNB according to various LTE/LTE-A transmission protocols.

A CSI-RS may be provided to improve link adaptation by providing a reference signal that occupies resource elements 310 usually allocated to PDSCH, which may provide more meaningful measures of channel quality. As noted above, characteristics of a CSI-RS, including locations of resource elements that contain a CSI-RS include a number of different available options that depend upon a variety of factors. In some implementations, for example, a CSI-RS configuration may be based on a configuration value between 0 and 31, that points to a look-up table that specifies a reference resource element 310 to be used for a CSI-RS. The actual resource elements 310 used by the CSI-RS may then be derived from this reference resource element using antenna specific offsets. Furthermore, different VCIDs may generate different CSI-RS sequences. Furthermore, a CSI-RS period may be defined in which the CSI-RS occupies a single subframe 305 per CSI-RS period. For example, the CSI-RS may occupy one subframe 305 per 5, 10, 20, 40, or 80 subframes.

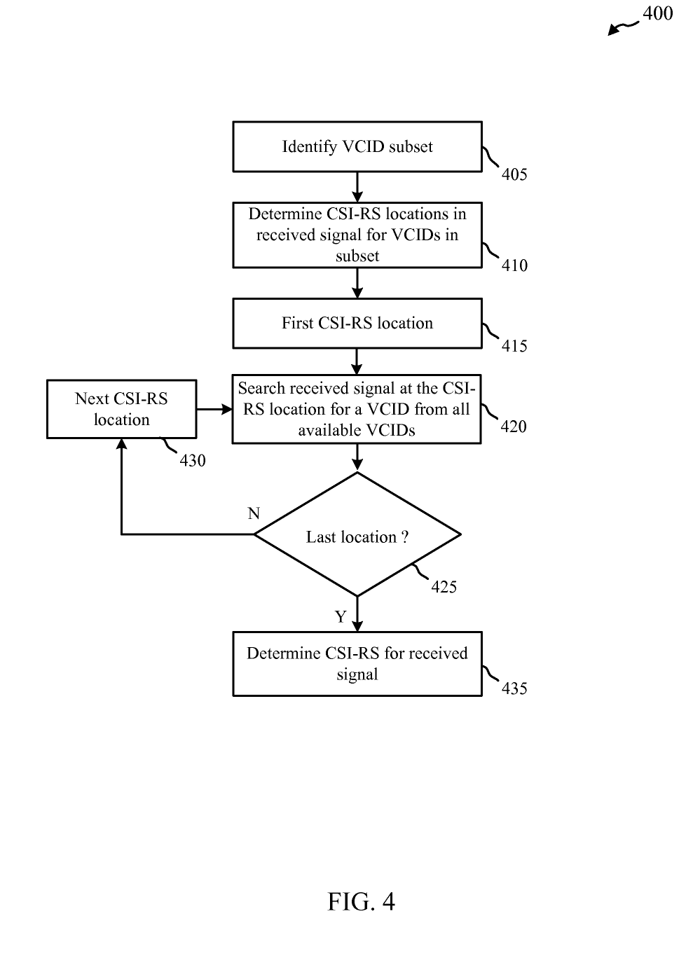

FIG. 4 illustrates a flow diagram of an example method 400 for identifying one or more CSI-RS from a non-serving cell according to various embodiments. The method 400 may be performed by, for example, the UEs 115 of FIG. 1 and/or UEs 215 of FIG. 2. While aspects of FIG. 4 are described with respect to a UE, in some embodiments the method 400 may be performed by, for example, an eNB 105 of FIG. 1 and/or an eNB 205 of FIG. 2, and resulting information may be provided to a UE that is served by the eNB.

At block 405, the UE identifies a VCID subset. The VCID subset may be identified according to one or more of a number of different techniques. For example, the subset of VCID candidates may be identified through random selection, or based on detected PCIs of non-serving cells. In other examples, an indication of available VCID candidates may be provided by a network entity through, for example, radio resource control (RRC) signaling. In further examples, the subset of VCID candidates may be identified based on cross-correlation measurements between VCID pairs from a set of available VCID candidates. According to some examples, the selected VCID subset may not necessarily include an actual VCID associated with a received signal from a non-serving cell.

Additionally or alternatively, a number of VCID subsets may be preset or preprogrammed on the UE, or may be provided to the UE through network signaling such as RRC signaling. In further examples, a number of VCID subsets may be established according to a communications standard. The particular VCID subset in such cases may be selected from the number of subsets based on, for example a CSI-RS location of a CSI-RS of the serving cell, and/or based on one or more detected PCI of a neighboring cell. In some examples, the particular VCID subset from the plurality of VCID subsets may be selected based on information received from a network entity of the wireless communications network that restricts allowed locations for a CSI-RS.

At block 410, the UE determines CSI-RS locations in a received signal for VCIDs in the VCID subset. The CSI-RS locations may include time-domain locations for one or more CSI-RS in the signal of the non-serving cell. Such CSI-RS time-domain locations may include, for example, a subframe configuration and a resource configuration for a CSI-RS contained in the received signal from the non-serving cell. The subframe configuration may provide information on a CSI-RS period and subframes within the CSI-RS period that include a CSI-RS, for example. The resource configuration may provide information on resources, such as slots and/or OFDM symbols within a subframe that include a CSI-RS.

At block 415, a first CSI-RS location is selected from the determined CSI-RS locations. The first CSI-RS location may be the first CSI-RS location in time associated with the received signal, for example. As noted above, the first CSI-RS location may include time domain locations associated with one or more CSI-RS received in one or more signals from a non-serving cell.

The UE, at block 420, then searches the received signal at the CSI-RS location from block 415 for a VCID from all available VCIDs. Thus, for the specific location, a complete search over all available VCID candidates is performed. Such a search may include frequency domain correlation to determine whether particular resource elements at the identified location include a CSI-RS. For example, the search may include searching for a CSI-RS sequence generated according to the VCID candidate at the CSI-RS location. In the event that a CSI-RS sequence corresponding to the VCID candidate is found, it may be determined that the particular CSI-RS location includes a CSI-RS.

At block 425, it is determined if the location is the last CSI-RS location that was identified at block 410. Such a determination may be made, for example, by determining if all of the CSI-RS locations determined at block 410 have been searched according to block 420. A UE may, for example, store a list of determined CSI-RS locations and also an indication of whether the CSI-RS location has been searched. Following the completion of a search according to block 420, the indication may be updated to indicate that associated CSI-RS locations have been searched.

If it is determined at block 425 that further CSI-RS locations remain to be searched, the next CSI-RS location is selected according to block 430. The next CSI-RS location may be selected based on a next location in a stored list that has not yet been searched according to block 420. Following the selection of the next CSI-RS location at block 430, the operations at blocks 420 and 425 are performed.

If it is determined at block 425 that the last CSI-RS location of the CSI-RS locations determined at block 410 has been searched, the UE determines one or more CSI-RS for the received signal at block 435. The determination of the one or more CSI-RS may include, for example, determining the subframe configuration, resource configuration, VCID, and/or an antenna port configuration for a CSI-RS contained in the received signal. Such a determination may be based on, for example, each of the particular resource elements searched at each of the determined CSI-RS locations.

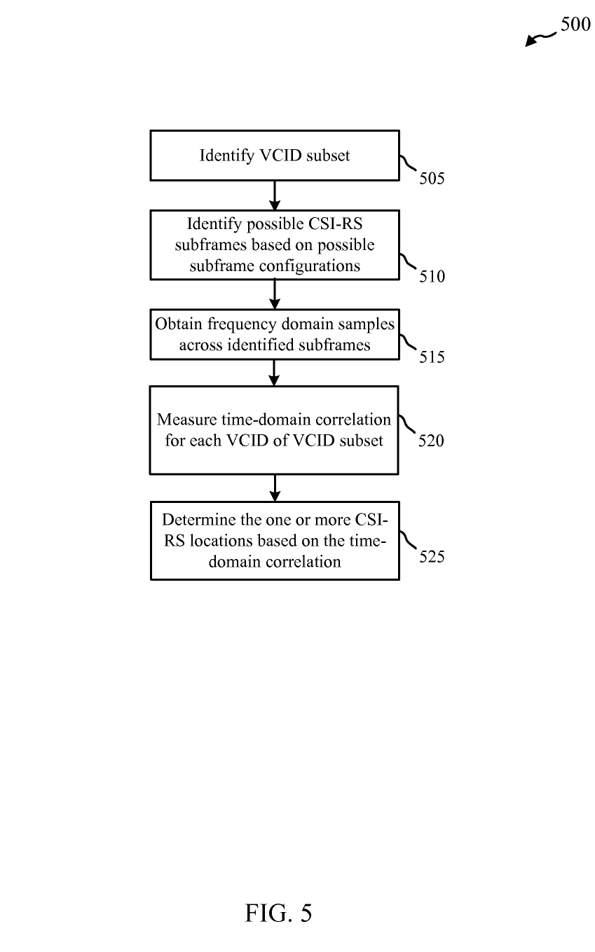

FIG. 5 illustrates a flow diagram of an example method 500 for identifying one or more CSI-RS locations in a signal received from a non-serving cell according to various embodiments. The method 500 may be performed byu, for example, the UEs 115 of FIG. 1 and/or UEs 215 of FIG. 2. While aspects of FIG. 5 are described with respect to a UE, in some embodiments the method 500 may be performed by, for example, an eNB 105 of FIG. 1 and/or eNB 205 of FIG. 2, and resulting information may be provided to a UE that is served by the eNB.

At block 505, the UE identifies a VCID subset. Block 505 may be performed as described above with reference to block 405 of FIG. 4.

At block 510, the UE may identify possible CSI-RS subframes based on possible subframe configurations. Such possible subframe configurations may be based on, for example, different CSI-RS periods and one or more related offsets such as discussed above with respect to FIG. 3, for VCIDs of the VCID subset. The possible subframes may include subframes where it is expected that a CSI-RS may be transmitted. According to some embodiments, the number of VCIDs in the VCID subset may be identified based on likelihood of misdetection or false alarms versus a size, and associated complexity, of the subset.

At block 515, the UE may obtain frequency domain samples across the identified subframes. For example, the UE may obtain samples from the entire frequency domain for each of the identified subframes. In some examples, frequency domain samples may be obtained for time periods that are likely to transmit a CSI-RS.

At block 520, the UE may measure a time-domain correlation for each VCID of the VCID subset. Such a measurement may include measuring a time-domain correlation of each of the received frequency domain samples across the subset of subframes for each VCID from the subset of VCID candidates.

At block 525, the UE may determine the locations of CSI-RS based on the time-domain correlation. As discussed above with respect to FIG. 4, the CSI-RS locations may include a subframe configuration and resource configuration. Following block 525, in some examples, operations 415 through 435 of FIG. 4 may be performed.

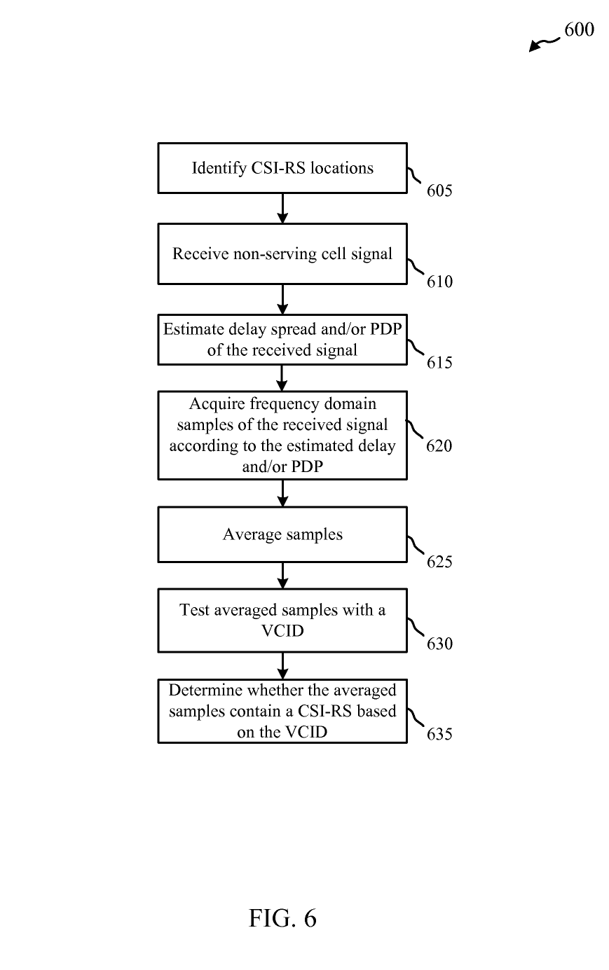

FIG. 6 illustrates a flow diagram of an example method 600 for identifying one or more CSI-RS from a non-serving cell according to various embodiments. The method 600 may be performed by, for example, the UEs 115 of FIG. 1 and/or UEs 215 of FIG. 2. While aspects of FIG. 6 are described with respect to a UE, in some embodiments the method 600 may be performed by, for example, an eNB 105 of FIG. 1 and/or eNB 205 of FIG. 2, and resulting information may be provided to a UE that is served by the eNB.

At block 605, the UE identifies one or more CSI-RS locations. CSI-RS locations may include time domain locations such as a subframe configuration and a resource configuration for one or more CSI-RS. The CSI-RS locations may be identified as described above with reference to blocks 405 and 410 of FIG. 4 and/or blocks 505-525 of FIG. 5.

At block 610, the UE may receive a non-serving cell signal. Such a signal may be received from one or more non-serving eNBs, for example, that may have an overlapping coverage area with a serving eNB.

The UE may then, at block 615, estimate one or more of a delay spread or power delay profile (PDP) of the received signal. Such an estimation may be made according to, for example a statistical evaluation of the spread of delayed signal components about a mean value of overall channel power. In some examples, the estimation may be based on one or more antenna ports associated with a common reference signal (CRS). According to some examples, the one or more CRS antenna ports to be used for the estimation may be signaled by a network entity, or may be selected autonomously based on at least one of a PCI, the CSI-RS location, or a VCID.

At block 620, the UE may acquire frequency domain samples of the received signal according to the estimated delay and/or PDP. The UE, in some examples, may obtain samples from the frequency domain for each CSI-RS location adjusted according to estimated delay spread and/or PDP.

At block 625, the UE may average the frequency domain samples. Such an average may be determined by, for example, averaging the frequency domain samples of the received signal according to the estimated delay spread or PDP to obtain an averaged sample. Such an averaged sample according to block 625 may reduce the likelihood of errors that may be associated with the individual samples acquired at block 620.

At block 630, the UE may test the averaged samples with the VCID. The testing may include a comparison between an expected signal associated with the VCID and the averaged samples. The testing may indicate a difference between the expected and averaged values, for example, which may be used in other operations related to identifying a CSI-RS in a received signal.

At block 635, the UE may determine whether the averaged frequency domain samples contain a CSI-RS based on the VCID. Such a determination may be made, for example, based on the difference between the expected and averaged values as discussed with respect to block 630. If the difference between the expected and averaged values meets one or more criteria, for example, it may be determined that the averaged frequency domain samples include a CSI-RS. If the difference is outside of the criteria, it may be determined that the averaged frequency domain samples do not include a CSI-RS, and another VCID may be tested.

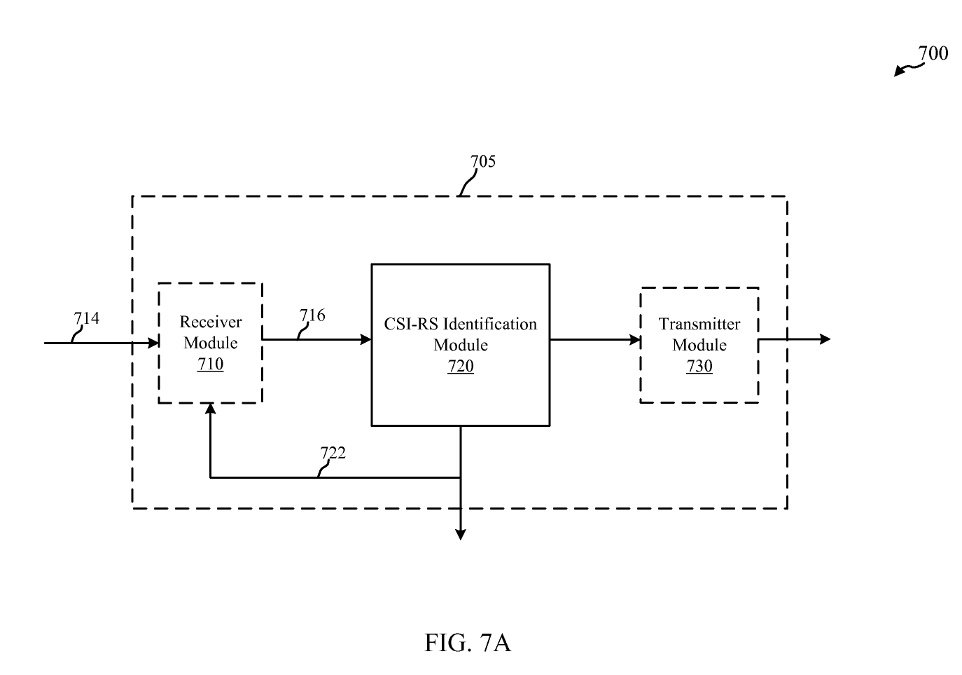

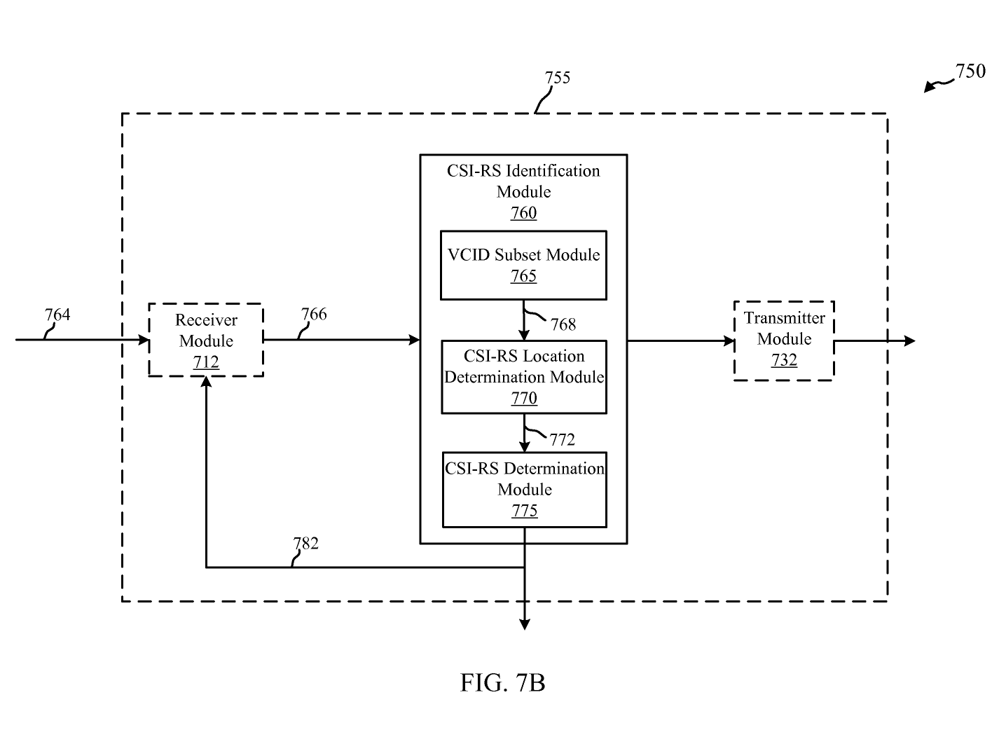

Referring now to FIG. 7A, a block diagram 700 illustrates a device 705 for use in wireless communications in accordance with various embodiments. In some embodiments, the device 705 may be an example of one or more aspects of the eNBs 105 and/or 205 and/or UEs 115 and/or 215 described with reference to FIGS. 1 and/or 2. The device 705 may also be a processor. The device 705 may include a receiver module 710, a CSI-RS identification module 720, and/or a transmitter module 730. Each of these components may be in communication with each other.

The components of the device 705 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 710 may be used to receive various types of data and/or control signals (i.e., transmissions) over one or more communication links of a wireless communications system, such as one or more communication links of the wireless communications systems 100 and/or 200 described with reference to FIG. 1 and/or 2. In some embodiments, the receiver module 710 may be or include a radio frequency (RF) receiver, such as an RF receiver operable to receive transmissions 714. The received transmissions 714 may include signals from a serving cell intended for a UE and also one or more interfering signals from non-serving cell(s). The receiver 710 may condition (e.g., filter, amplify, downconvert, and digitize) the received signal to obtain input samples 716 and pass the input samples 716 to the CSI-RS identification module 720.

In some embodiments, the transmitter module 730 may be or include an RF transmitter. The transmitter module 730 may be used to transmit various types of data and/or control signals (i.e., transmissions) over one or more communication links of a wireless communications system, such as one or more communication links of the wireless communications systems 100 and/or 200 described with reference to FIGS. 1 and/or 2.

In some embodiments, the CSI-RS identification module 720 may process the input samples 716 and detect one or more CSI-RS that may be received in one or more signals from one or more non-serving cells. The CSI-RS detection may be performed according to any one or more of the techniques described above. According to some embodiments, CSI-RS detection may be performed by first determining CSI-RS locations based on evaluations of a subset of VCID candidates, and then determining whether one or more CSI-RS is present in the received signal(s) based on a search over all VCID candidates at the determined CSI-RS locations. The CSI-RS identification module 720 may determine CSI-RS information 722 related to the detected CSI-RS signals. CSI-RS information 722 may include a subframe configuration, a resource configuration, a VCID, and/or a number of antenna ports associated with a CSI-RS included in a received signal. The CSI-RS identification module 720 may pass the CSI-RS information 722 to other modules (e.g., receiver 710, etc.) for use in additional processing of the received signals 714 (e.g., channel estimation, interference cancellation, etc.) or other functions.

Referring now to FIG. 7B, a block diagram 750 illustrates a device 755 for use in wireless communications in accordance with various embodiments. In some embodiments, the device 755 may be an example of one or more aspects of the eNBs 105, 205 and/or UEs 115, 215 described with reference to FIGS. 1 and/or 2. The device 755 may also be a processor. The device 755 may include a receiver module 712, a CSI-RS identification module 760, and/or a transmitter module 732. Each of these components may be in communication with each other.

The components of the device 755 may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some embodiments, the receiver module 712 may be an example of the receiver module 710 of FIG. 7A. The receiver module 712 may be used to receive various types of data and/or control signals (i.e., transmissions) over one or more communication links of a wireless communications system, such as one or more communication links of the wireless communications systems 100 and/or 200 described with reference to FIGS. 1 and/or 2. In some embodiments, the receiver module 712 may be or include a radio frequency (RF) receiver, such as an RF receiver operable to receive transmissions 764. The received transmissions 764 may include signals from a serving cell intended for a UE and also one or more interfering signals from non-serving cell(s). The receiver 712 may condition (e.g., filter, amplify, downconvert, and digitize) the received signal to obtain input samples 766 and pass the input samples 766 to the CSI-RS identification module 760.

In some embodiments, the transmitter module 732 may be an example of the transmitter module 730 of FIG. 7A. The transmitter module 732 may be or include an RF transmitter. The transmitter module 732 may be used to transmit various types of data and/or control signals (i.e., transmissions) over one or more communication links of a wireless communications system, such as one or more communication links of the wireless communications systems 100 and/or 200 described with reference to FIGS. 1 and/or 2.

In some embodiments, the CSI-RS identification module 760 may process the input samples 766 and detect one or more CSI-RS that may be received in one or more signals from one or more non-serving cells. The CSI-RS identification module 760 may be an example of the CSI-RS identification module 720 described with reference to FIG. 7A and may include a VCID subset module 765, a CSI-RS location determination module 770, and a CSI-RS determination module 775. Each of these components may be in communication with each other.

In some embodiments, the VCID subset module 765 may identify a VCID subset as described above with respect to FIG. 2, FIG. 3, block 405 of FIG. 4, and/or block 505 of FIG. 5. The VCID subset module 765 may provide VCID subset information 768 to the CSI-RS location determination module 770. The CSI-RS location determination module 770 may receive the VCID subset information 768 and the input samples 766 obtained from signals received from the non-serving cell, and may determine CSI-RS locations 772 based on evaluations of a subset of VCID candidates, such as described above with reference to FIG. 2, FIG. 3, block 410 of FIG. 4, blocks 510-525 of FIG. 5, and/or block 605 of FIG. 6. The CSI-RS determination module 775 may determine whether one or more CSI-RS is present in the received signal(s) based on a search over all VCID candidates at CSI-RS locations 772 determined by the CSI-RS location determination module 770, such as described above with reference to FIG. 2, FIG. 3, blocks 420-435 of FIG. 4, and/or blocks 610-635 of FIG. 6. The CSI-RS identification module 760 may determine CSI-RS information 782 related to the detected CSI-RS signals. CSI-RS information 782 may include a subframe configuration, a resource configuration, a VCID, and/or a number of antenna ports associated with a CSI-RS included in a received signal. The CSI-RS identification module 760 may pass the CSI-RS information 782 to other modules (e.g., receiver 712, etc.) for use in additional processing of the received signals 764 (e.g., channel estimation, interference cancellation, etc.) or other functions.

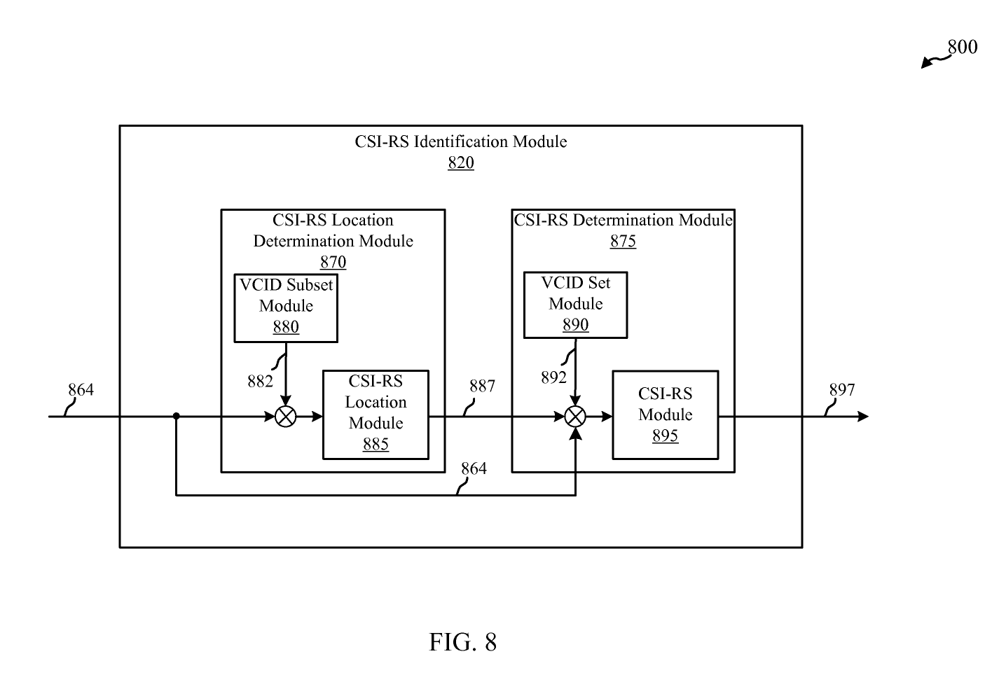

Referring now to FIG. 8, a block diagram 800 illustrates a CSI-RS identification module 820 for use in wireless communications in accordance with various embodiments. In some embodiments, the CSI-RS identification module 820 may be an example of one or more aspects of the CSI-RS identification modules 720 and/or 760 described with reference to FIGS. 7A and/or 7B. The CSI-RS identification module 820 may also illustrate aspects of eNBs 105, 205 and/or UEs 115, 215 described with reference to FIG. 1 and/or 2. The CSI-RS identification module 820 may also be a processor. The CSI-RS identification module 820 may include a CSI-RS location determination module 870, and a CSI-RS determination module 875. Each of these components may be in communication with each other.

The components of the CSI-RS identification module 820, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some embodiments, the CSI-RS location determination module 870 may determine CSI-RS locations 887, and may be an example of CSI-RS location determination module 770 of FIG. 7B, for example. The CSI-RS location determination module 870 may include a VCID subset module 880 and a CSI-RS location module 885. The VCID subset module 880 may identify a VCID subset and provide VCID subset information 882 to the CSI-RS location module 885, such as described above with respect to FIG. 2, FIG. 3, block 405 of FIG. 4, and/or block 505 of FIG. 5. The CSI-RS location module 885 may receive the VCID subset information 882 and signals received from the non-serving cell 864, and provide CSI-RS location information 887 based on evaluations of a subset of VCID candidates, such as described above, for example, with reference to FIG. 2, FIG. 3, block 410 of FIG. 4, and/or blocks 510-525 of FIG. 5.

The CSI-RS determination module 875 may determine whether one or more CSI-RS is present in the received signal(s), and may be an example of CSI-RS determination module 775 of FIG. 7B, for example. The CSI-RS determination module 875 may include a VCID set module 890 and a CSI-RS module 895. The VCID set module 890 may provide each available VCID 892 from a set of available VCIDs to the CSI-RS module 895, such as described above with respect to FIG. 2, FIG. 3, and/or block 420 of FIG. 4. The CSI-RS module 895 may receive the CSI-RS location information 887 from CSI-RS location determination module 870, the VCID information 892 from the VCID set module 890, and the received signal 864, and determine the presence of one or more CSI-RS in the received signal(s) 864, such as described above, for example, with reference to FIG. 2, FIG. 3, blocks 415-435 of FIG. 4, and/or blocks 610-635 of FIG. 6. The CSI-RS determination module 875 may determine CSI-RS information 897 related to the detected CSI-RS signals. CSI-RS information 897 may include a subframe configuration, a resource configuration, a VCID, and/or a number of antenna ports associated with a CSI-RS included in a received signal. Such a determination may be based on, for example, each of the particular resource elements searched at each of the determined CSI-RS locations 887. The CSI-RS determination module 875 may pass the CSI-RS information 897 to other modules such as a receiver (not shown), interference cancellation module (not shown), and the like, for use in additional processing of the received signals (e.g., channel estimation, interference cancellation, etc.) or other functions.

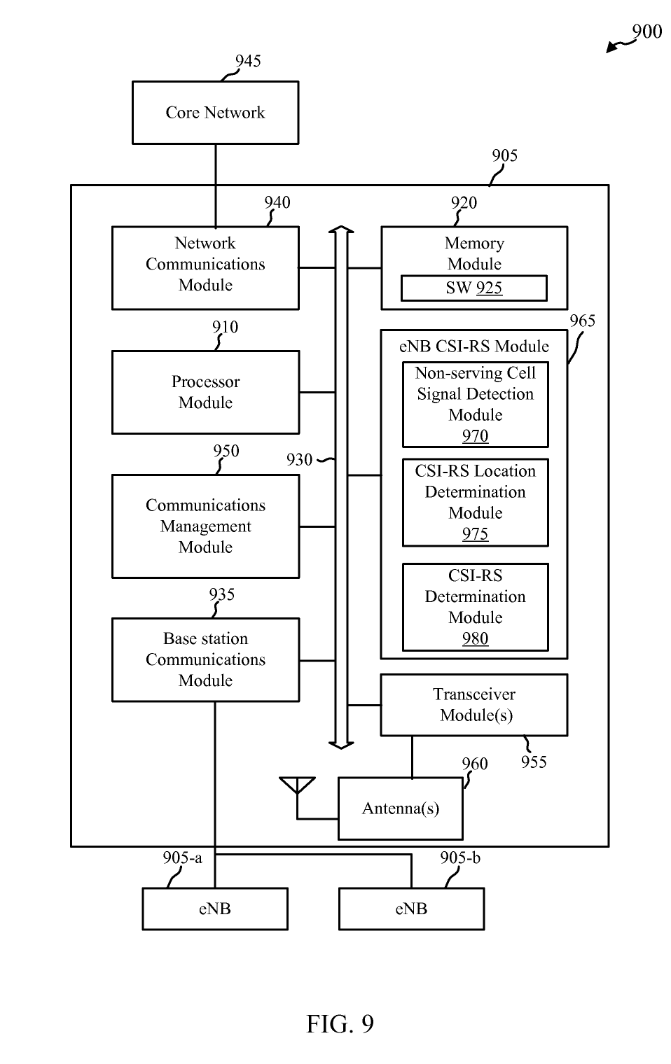

Turning to FIG. 9, a block diagram 900 is shown that illustrates an eNB 905 configured for CSI-RS detection. In some embodiments, the eNB 905 may be an example of one or more aspects of the eNBs 105, 204 or devices 705 and/or 755 described with reference to FIGS. 1, 2, 7A and/or 7B. The eNB 905 may be configured to implement at least some of the CSI-RS determination features and functions described with respect to FIGS. 1, 2, 3, 4, 5, 6, 7A, 7B, and/or 8. The eNB 905 may include a processor module 910, a memory module 920, one or more transceiver module(s) 955, one or more antenna antenna(s) 960, and an eNB CSI-RS module 965. The eNB 905 may also include one or both of a base station communications module 935 and a network communications module 940. Each of these components may be in communication with each other, directly or indirectly, over one or more buses 930.

The memory module 920 may include random access memory (RAM) and/or read-only memory (ROM). The memory module 920 may store computer-readable, computer-executable software (SW) code 925 containing instructions that are configured to, when executed, cause the processor module 910 to perform various functions described herein for determining one or more aspects related to CSI-RS signals from non-serving cells of a UE, including providing one or more forms of network assistance, such as described above, and/or performing CSI-RS detection for the non-serving cells and providing this information to a UE in communication with an eNB 905. Alternatively, the software code 925 may not be directly executable by the processor module 910 but be configured to cause the eNB 905, e.g., when compiled and executed, to perform various of the functions described herein.

The processor module 910 may include an intelligent hardware device, e.g., a central processing unit (CPU), a microcontroller, an ASIC, etc. The processor module 910 may process information received through the transceiver module(s) 955, the base station communications module 935, and/or the network communications module 940. The processor module 910 may also process information to be sent to the transceiver module(s) 955 for transmission through the antenna(s) 960, to the base station communications module 935 for transmission to one or more other base stations or eNBs 905-a and 905-b, and/or to the network communications module 940 for transmission to a core network 945, which may be an example of aspects of the core network 130 described with reference to FIG. 1. The processor module 910 may handle, alone or in connection with the eNB CSI-RS Module 965, various aspects of CSI-RS detection in signals from non-serving cells.

The transceiver module(s) 955 may include a modem configured to modulate packets and provide the modulated packets to the antenna(s) 960 for transmission, and to demodulate packets received from the antenna(s) 960. The transceiver module(s) 955 may be implemented as one or more transmitter modules and one or more separate receiver modules. The transceiver module(s) 955 may be configured to communicate bi-directionally, via the antenna(s) 960, with one or more of the UEs 115, 215 and/or devices 705, 715 described with reference to FIGS. 1, 2, 7A and/or 7B, for example. The eNB 905 may typically include multiple antennas 960 (e.g., an antenna array). The eNB 905 may communicate with the core network 945 through the network communications module 940. The eNB 905 may communicate with other base stations or eNBs, such as the eNBs 905-a and 905-b, using the base station communications module 935.

According to the architecture of FIG. 9, the eNB 905 may further include a communications management module 950. The communications management module 950 may manage communications with other base stations, eNBs, and/or devices. The communications management module 950 may be in communication with some or all of the other components of the eNB 905 via the bus or buses 930. Alternatively, functionality of the communications management module 950 may be implemented as a component of the transceiver module(s) 955, as a computer program product, and/or as one or more controller elements of the processor module 910.

The eNB CSI-RS module 965 may be configured to perform and/or control some or all of the CSI-RS determination functions or aspects described with reference to FIGS. 1, 2, 3, 4, 5, 6, 7A, 7B, and/or 8 related to CSI-RS detection and/or network assistance to a UE related to CSI-RS detection. The eNB CSI-RS module 965 may include a non-serving cell signal detection module 970 configured to detect signals from one or more neighboring eNBs, such as eNBs 905-a and 905-b. Non-serving cell signal detection module 970 may be an example of non-serving cell signal detection module 765 of FIG. 7B, and/or non-serving cell signal detection module 865 of FIG. 8, for example. The eNB CSI-RS module 965 may include a CSI-RS location determination module 975 configured to detect locations of one or more CSI-RS in a received signal. The CSI-RS location determination module 975 may be an example of CSI-RS location determination module 770 of FIG. 7B, and/or CSI-RS location determination module 870 of FIG. 8, for example. The CSI-RS determination module 980 may determine whether one or more CSI-RS is present in the received signal(s). The CSI-RS determination module 980 may be an example of CSI-RS determination module 775 of FIG. 7B, and/or CSI-RS determination module 875 of FIG. 8, for example. The eNB CSI-RS module 965, or portions of it, may include a processor and/or some or all of the functionality of the eNB CSI-RS module 965 may be performed by the processor module 910 and/or in connection with the processor module 910.

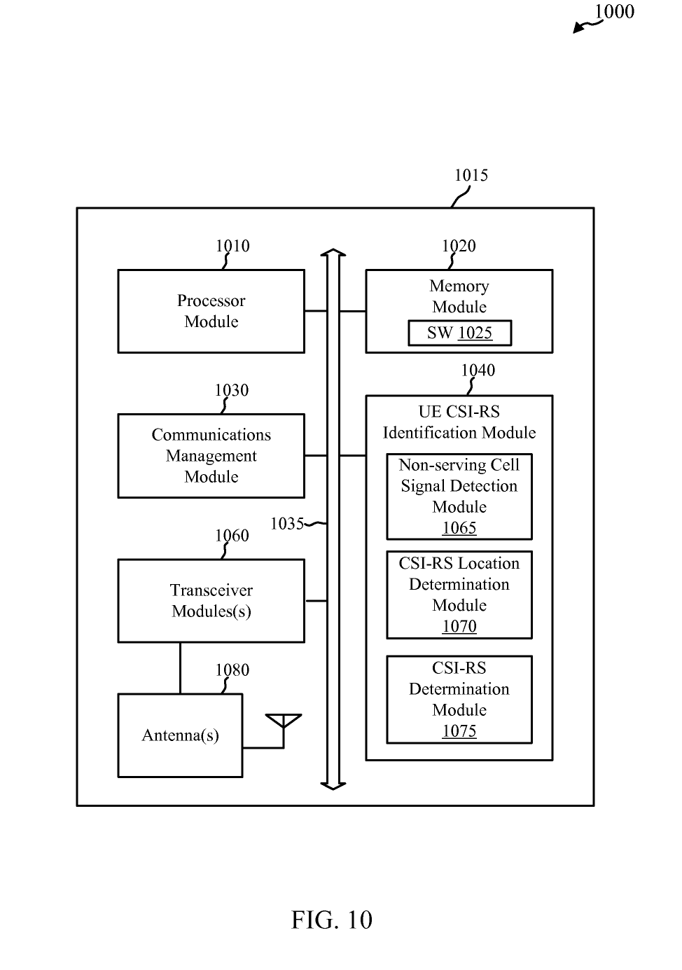

Turning to FIG. 10, a block diagram 1000 is shown that illustrates a UE 1015 configured for CSI-RS detection in signals received from non-serving cells. The UE 1015 may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The UE 1015 may have an internal power supply (not shown), such as a small battery, to facilitate mobile operation. In some embodiments, the UE 1015 may be an example of one or more of the UEs 115, 215 and/or devices 705, 755 described with reference to FIGS. 1, 2, 7A and/or 7B. The UE 1015 may be configured to communicate with one or more of the eNBs 105, 205 and/or devices 705, 755 described with reference to FIGS. 1, 2, 7A and/or 7B.

The UE 1015 may include a processor module 1010, a memory module 1020, one or more transceiver module(s) 1060, one or more antenna(s) 1080, and/or a UE CSI-RS identification module 1040. Each of these components may be in communication with each other, directly or indirectly, over one or more buses 1035.

The memory module 1020 may include RAM and/or ROM. The memory module 1020 may store computer-readable, computer-executable software (SW) code 1025 containing instructions that are configured to, when executed, cause the processor module 1010 to perform various functions described herein for determining the presence of one or more CSI-RS in a signal from a non-serving cell. Alternatively, the software code 1025 may not be directly executable by the processor module 1010 but be configured to cause the UE 1015 (e.g., when compiled and executed) to perform various of the UE functions described herein.

The processor module 1010 may include an intelligent hardware device, e.g., a CPU, a microcontroller, an ASIC, etc. The processor module 1010 may process information received through the transceiver module(s) 1060 and/or information to be sent to the transceiver module(s) 1060 for transmission through the antenna(s) 1080. The processor module 1010 may handle, alone or in connection with the UE CSI-RS identification module 1040, various aspects of determining CSI-RS presence and properties in received signals from one or more non-serving cells.

The transceiver module(s) 1060 may be configured to communicate bi-directionally with eNBs. The transceiver module(s) 1060 may be implemented as one or more transmitter modules and one or more separate receiver modules. The transceiver module(s) 1060 may support LTE/LTE-A communications. The transceiver module(s) 1060 may include a modem configured to modulate packets and provide the modulated packets to the antenna(s) 1080 for transmission, and to demodulate packets received from the antenna(s) 1080. While the UE 1015 may include a single antenna, there may be embodiments in which the UE 1015 may include multiple antennas 1080.

According to the architecture of FIG. 10, the UE 1015 may further include a communications management module 1030. The communications management module 1030 may manage communications with various base stations or eNBs. The communications management module 1030 may be a component of the UE 1015 in communication with some or all of the other components of the UE 1015 over the one or more buses 1035. Alternatively, functionality of the communications management module 1030 may be implemented as a component of the transceiver module(s) 1060, as a computer program product, and/or as one or more controller elements of the processor module 1010.

The UE CSI-RS identification module 1040 may be configured to perform and/or control some or all of the UE CSI-RS identification functions or aspects described in FIGS. 1, 2, 3, 4, 5, 6, 7, 8 and/or 9 related to determining one or more CSI-RS in signals received from one or more non-serving cells. The UE CSI-RS identification module 1040 may include a non-serving cell signal detection module 1065 configured to detect signals from one or more non-serving cells. The non-serving cell signal detection module 1065 may be an example of non-serving cell signal detection module 765 of FIG. 7B, and/or non-serving cell signal detection module 865 of FIG. 8, for example. The UE CSI-RS identification module 965 may include a CSI-RS location determination module 1070 configured to detect locations of one or more CSI-RS in a received signal. The CSI-RS location determination module 1070 may be an example of CSI-RS location determination module 770 of FIG. 7B, and/or CSI-RS location determination module 870 of FIG. 8, for example. The CSI-RS determination module 1075 may determine whether one or more CSI-RS is present in the received signal(s). The CSI-RS determination module 1075 may be an example of CSI-RS determination module 775 of FIG. 7B, and/or CSI-RS determination module 875 of FIG. 8, for example. The UE CSI-RS identification module 1040, or portions of it, may include a processor and/or some or all of the functionality of the UE CSI-RS identification module 1040 may be performed by the processor module 1010 and/or in connection with the processor module 1010.

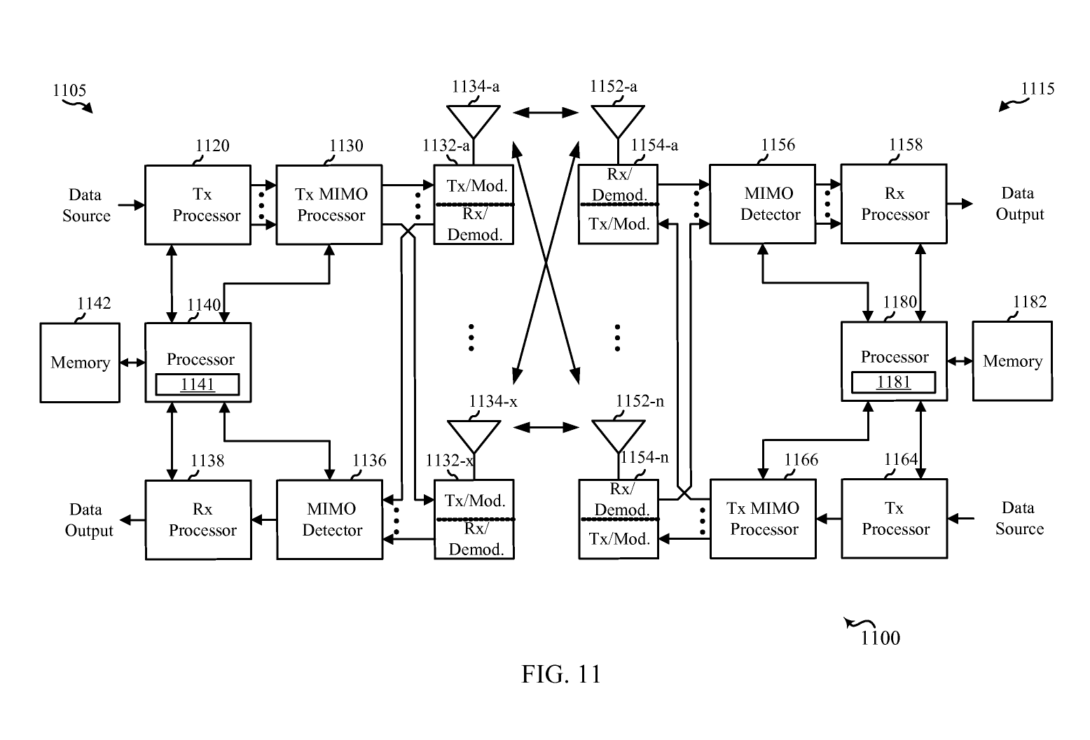

Turning next to FIG. 11, a block diagram of a multiple-input multiple-output (MIMO) communication system 1100 is shown including an eNB 1105 and a UE 1115. The eNB 1105 and the UE 1115 may support LTE-based communications, for example. The eNB 1105 may be an example of one or more aspects of the eNBs 105, 205 and/or devices 705, 755, and/or 905 described with reference to FIGS. 1, 2, 7A, 7B, and/or 9, while the UE 1115 may be an example of one or more aspects of the UEs 115, 215 and/or devices 705, 755, and/or 1015 described with reference to FIGS. 1, 2, 7A, 7B, and/or 10. The system 1100 may illustrate aspects of the wireless communications systems 100, and/or 200 described with reference to FIGS. 1 and/or 2, and may perform CSI-RS determination in received signals from non-serving cells according to one or more of various different techniques such as described with reference to FIGS. 2, 3, 4, 5 and/or 6.

The eNB 1105 may be equipped with antennas 1134-a through 1134-x, and the UE 1115 may be equipped with antennas 1152-a through 1152-n. In the system 1100, the eNB 1105 may be able to send data over multiple communication streams at the same time. Each communication stream may be called a “layer” and the “rank” of a communication link may indicate the number of layers used for communication. For example, in a 2×2 MIMO system where eNB 1105 transmits two “layers,” the rank of the communication link between the eNB 1105 and the UE 1115 may be two.

At the eNB 1105, a transmit (Tx) processor 1120 may receive data from a data source. The transmit processor 1120 may process the data. The transmit processor 1120 may also generate reference symbols and/or a cell-specific reference signal. A transmit (Tx) MIMO processor 1130 may perform spatial processing (e.g., precoding) on data symbols, control symbols, and/or reference symbols, if applicable, and may provide output symbol streams to the transmit (Tx) modulators 1132-a through 1132-x. Each modulator 1132 may process a respective output symbol stream (e.g., for OFDM, etc.) to obtain an output sample stream. Each modulator 1132 may further process (e.g., convert to analog, amplify, filter, and upconvert) the output sample stream to obtain a downlink (DL) signal. In one example, DL signals from modulators 1132-a through 1132-x may be transmitted via the antennas 1134-a through 1134-x, respectively.

At the UE 1115, the antennas 1152-a through 1152-n may receive the DL signals from the eNB 1105 and may provide the received signals to the receive (Rx) demodulators 1154-a through 1154-n, respectively. Each demodulator 1154 may condition (e.g., filter, amplify, downconvert, and digitize) a respective received signal to obtain input samples. Each demodulator 1154 may further process the input samples (e.g., for OFDM, etc.) to obtain received symbols. A MIMO detector 1156 may obtain received symbols from all the demodulators 1154-a through 1154-n, perform MIMO detection on the received symbols if applicable, and provide detected symbols. A receive (Rx) processor 1158 may process (e.g., demodulate, deinterleave, and decode) the detected symbols, providing decoded data for the UE 1115 to a data output, and provide decoded control information to a processor 1180, or memory 1182. The processor 1180 may include a module or function 1181 that may perform various functions related to detection of CSI-RS in one or more signals received from a non-serving cell. For example, the module or function 1181 may perform some or all of the functions of the CSI-RS identification modules 720, 760, and/or 820 described with reference to FIGS. 7A, 7B, and/or 8, and/or of the UE CSI-RS identification module 1040 described with reference to FIG. 10.

On the uplink (UL), at the UE 1115, a transmit (Tx) processor 1164 may receive and process data from a data source. The transmit processor 1164 may also generate reference symbols for a reference signal. The symbols from the transmit processor 1164 may be precoded by a transmit (Tx) MIMO processor 1166 if applicable, further processed by the transmit (Tx) modulators 1154-a through 1154-n (e.g., for SC-FDMA, etc.), and be transmitted to the eNB 1105 in accordance with the transmission parameters received from the eNB 1105. At the eNB 1105, the UL signals from the UE 1115 may be received by the antennas 1134, processed by the receiver (Rx) demodulators 1132, detected by a MIMO detector 1136 if applicable, and further processed by a receive (Rx) processor 1138. The receive processor 1138 may provide decoded data to a data output and to the processor 1140. The processor 1140 may include a module or function 1141 that may perform various functions related to detection of CSI-RS in one or more signals received from a non-serving cell. For example, the module or function 1141 may perform some or all of the functions of the CSI-RS identification modules 720, 760, and/or 820 described with reference to FIG. 7A, 7B, and/or 8, and/or of the eNB CSI-RS module 965 described with reference to FIG. 9.

The components of the eNB 1105 may, individually or collectively, be implemented with one or more ASICs adapted to perform some or all of the applicable functions in hardware. Each of the noted modules may be a means for performing one or more functions related to operation of the system 1100. Similarly, the components of the UE 1115 may, individually or collectively, be implemented with one or more ASICs adapted to perform some or all of the applicable functions in hardware. Each of the noted components may be a means for performing one or more functions related to operation of the system 1100.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, instructions, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for identifying one or more channel state information reference signal (CSI-RS) from a non-serving cell in a wireless communications network, comprising:
identifying a subset of virtual cell identity (VCID) candidates;
determining one or more CSI-RS locations for one or more CSI-RS in a received signal from a non-serving cell based on the subset of VCID candidates; and
identifying one or more CSI-RS in the received signal based on the one or more CSI-RS locations.

2. The method of claim 1, wherein the identifying the one or more CSI-RS comprises determining one or more of a subframe configuration, a resource configuration, a VCID, or an antenna port configuration for a CSI-RS contained in the received signal.

3. The method of claim 1, wherein the identifying the one or more CSI-RS comprises:
for each CSI-RS location from the one or more CSI-RS locations, searching for a VCID, in a set of available VCIDs, corresponding to a CSI-RS sequence generated according to the VCID at the CSI-RS location; and
determining the one or more CSI-RS responsive to the searching.

4. The method of claim 3, wherein the searching comprises:
estimating one or more of a delay spread or power delay profile (PDP) of the received signal;
averaging frequency domain samples of the received signal according to the estimated delay or PDP; and
testing the averaged frequency domain samples with the VCID to determine whether the averaged frequency domain samples contain a CSI-RS based on the VCID.

5. The method of claim 4, wherein the estimating is based on one or more antenna ports associated with a common reference signal (CRS).

6. The method of claim 5, wherein the one or more CRS antenna port to be used for the estimation is signaled by a network entity of the wireless communications network.

7. The method of claim 5, wherein the one or more CRS antenna port to be used for the estimation is selected autonomously based on at least one of a physical cell identity (PCI), the CSI-RS location, or the VCID.

8. The method of claim 1, wherein the identifying the subset of VCID candidates comprises:
selecting the subset of VCID candidates from a plurality of subsets of VCID candidates.

9. The method of claim 8, further comprising:
identifying one or more particular CSI-RS locations,
wherein the selecting comprises selecting the subset of VCID candidates from the plurality of subsets of VCID candidates responsive to the identifying.

10. The method of claim 9, wherein the identifying one or more particular CSI-RS locations is based on information received from a network entity of the wireless communications network that restricts allowed locations for a CSI-RS.

11. The method of claim 8, wherein the plurality of subsets of VCID candidates is provided in radio resource control (RRC) signaling.

12. The method of claim 1, wherein the one or more CSI-RS locations comprise time-domain locations.

13. The method of claim 12, wherein the CSI-RS time-domain locations comprise a subframe configuration and a resource configuration for a CSI-RS contained in the received signal.

14. The method of claim 12, wherein the determining the one or more CSI-RS locations comprises:
identifying a subset of subframes;
measuring a time-domain correlation of received frequency domain samples across the subset of subframes for each VCID from the subset of VCID candidates; and
determining the one or more CSI-RS locations based on the measured time-domain correlation.

15. The method of claim 1, wherein the identifying the subset of VCID candidates comprises selecting the subset of VCID candidates based on, one or more of:
a physical cell identifier (PCI) of one or more non-serving cells;
a random selection from a set of available VCID candidates;
an indication of available VCID candidates provided by a network entity of the wireless communications network;
cross-correlation measurements between VCID pairs from a set of available VCID candidates;
information provided by a network entity of the wireless communications network;
or a combination thereof.

16. The method of claim 1, wherein the one or more CSI-RS locations is determined irrespective of whether a CSI-RS contained in the received signal has a VCID in the identified subset of VCID candidates.

17. An apparatus for identifying one or more channel state information reference signal (CSI-RS) from a non-serving cell in a wireless communications network, comprising:
means for identifying a subset of virtual cell identity (VCID) candidates;
means for determining one or more CSI-RS locations for one or more CSI-RS in a received signal from a non-serving cell based on the subset of VCID candidates; and
means for identifying one or more CSI-RS in the received signal based on the one or more CSI-RS locations.

18. The apparatus of claim 17, wherein the means for identifying the one or more CSI-RS determines one or more of a subframe configuration, a resource configuration, a VCID, or an antenna port configuration for a CSI-RS contained in the received signal.

19. The apparatus of claim 17, wherein the means for identifying the one or more CSI-RS, for each CSI-RS location from the one or more CSI-RS locations, searches for a VCID, in a set of available VCIDs, corresponding to a CSI-RS sequence generated according to the VCID at the CSI-RS location, and determines the one or more CSI-RS responsive to the search.

20. The apparatus of claim 17, wherein the means for identifying the subset of VCID candidates selects the subset of VCID candidates based on, one or more of:
a physical cell identifier (PCI) of one or more non-serving cells;
a random selection from a set of available VCID candidates;
a set of available VCID candidates provided by a network entity of the wireless communications network;
cross-correlation measurements between VCID pairs from a set of available VCID candidates;
information provided by a network entity of the wireless communications network;
or a combination thereof.

21. The apparatus of claim 17, wherein the one or more CSI-RS locations is determined irrespective of whether a CSI-RS contained in the received signal has a VCID in the identified subset of VCID candidates.

22. A device for identifying one or more channel state information reference signal (CSI-RS) from a non-serving cell in a wireless communications network, comprising:
a processor; and
a memory in electronic communication with the processor, the memory embodying instructions, the instructions being executable by the processor to:
identify a subset of virtual cell identity (VCID) candidates;
determine one or more CSI-RS locations for one or more CSI-RS in a received signal from a non-serving cell based on the subset of VCID candidates; and
identify one or more CSI-RS in the received signal based on the one or more CSI-RS locations.

23. The device of claim 22, the memory further embodying instructions being executable by the processor to:
determine one or more of a subframe configuration, a resource configuration, a VCID, or an antenna port configuration for a CSI-RS contained in the received signal.

24. The device of claim 22, the memory further embodying instructions being executable by the processor to:
for each CSI-RS location from the one or more CSI-RS locations, search for a VCID, in a set of available VCIDs, corresponding to a CSI-RS sequence generated according to the VCID at the CSI-RS location; and
determine the one or more CSI-RS responsive to the searching.

25. The device of claim 24, the memory further embodying instructions being executable by the processor to:
estimate one or more of a delay spread or power delay profile (PDP) of the received signal;
average frequency domain samples of the received signal according to the estimated delay or PDP; and
test the averaged frequency domain samples with the VCID to determine whether the averaged frequency domain samples contain a CSI-RS based on the VCID.

26. The device of claim 22, the memory further embodying instructions being executable by the processor to:
select the subset of VCID candidates from a plurality of subsets of VCID candidates.

27. The device of claim 26, the memory further embodying instructions being executable by the processor to:
identify one or more particular CSI-RS locations; and
select the subset of VCID candidates from the plurality of subsets of VCID candidates responsive to the identification.

28. The device of claim 22, wherein the CSI-RS locations comprise a subframe configuration and a resource configuration for a CSI-RS contained in the received signal.

29. The device of claim 22, the memory further embodying instructions being executable by the processor to:
identify a subset of subframes;
measure a time-domain correlation of received frequency domain samples across the subset of subframes for each VCID from the subset of VCID candidates; and
determine the one or more CSI-RS locations based on the measured time-domain correlation.

30. A non-transitory computer-readable medium for identifying one or more channel state information reference signal (CSI-RS) from a non-serving cell in a wireless communications network, comprising code for:
identifying a subset of virtual cell identity (VCID) candidates;
determining one or more CSI-RS locations for one or more CSI-RS in a received signal from a non-serving cell based on the subset of VCID candidates; and
identifying one or more CSI-RS in the received signal based on the one or more CSI-RS locations.
